(19) United States
(12) Patent Application Publication
(10) Pub. No.: US 2024/0104502 A1
(43) Pub. Date: Mar. 28, 2024

(54) Real-time Consortium Building System, Method, and Computer Program Product

(71) Applicant: Vicoland GmbH, Frankfurt am Main (DE)

(72) Inventors: Javier Diaz Jimenez, Andalucia (ES); Alexander McCullagh, Darmstadt (DE); Enrique Leon-Prado, Coripe (ES); Andreas Habsburg-Lothringen, Frankfurt am Main (DE)

(73) Assignee: Vicoland GmbH, Frankfurt am Main (DE)

(21) Appl. No.: 18/472,222

(22) Filed: Sep. 22, 2023

Related U.S. Application Data
(60) Provisional application No. 63/409,411, filed on Sep. 23, 2022.

(51) Int. Cl. G06Q 10/10; G06Q 10/1053

(52) U.S. Cl. CPC G06Q 10/103; G06Q 10/1053

(57) ABSTRACT

Disclosed herein is a networked computer system, method, and computer program product for forming a consortium of a general contractor and subcontractors in an online work platform that enter into a contract with a client to complete a work project. In an embodiment, the consortium is a single legal entity with liability protection for the consortium (e.g., a registered LLC). The system processor automatedly generates a signed client's contract and signed subcontractors' contracts with the consortium when the client transmits approval of a general contractor's draft proposal. When the work project is amended, such as by adding a milestone or task, the system processor automatedly generates signed addendums to the client's contract with the consortium, and between the general contractor/consortium and existing subcontractor(s), or generates a new signed contract if a new subcontractor is hired. The system then generates and stores a PDF version of the signed contracts with addendums.

### CROSS-REFERENCE TO RELATED APPLICATIONS

This application claims the benefit of U.S. Provisional Application No. 63/409,411, filed 23 Sep. 2022, and entitled “Real-time Consortium Building System, Method, and Computer Program Product”. The disclosure of this application is hereby incorporated by reference in its entirety.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to online work platforms comprising networked computer systems, methods, and computer program products that facilitate clients hiring online general contractors, who subsequently hire online one or more sub-contractors. The contractor and the one or more sub-contractor(s) together form a consortium. One contract is executed between the consortium and the client, and then the computer system allows updates to the contract without having to execute a new contract with each member of the consortium.

### BACKGROUND OF THE INVENTION

There are a multitude of online work platforms that allow a client to hire one or more freelancers to perform work that can be done remotely (e.g., a computer program to perform one or more of the milestones required in a contract). If the contract needs to be updated, such as changing a work milestone or hiring new freelancers for a new milestone, then the old contract needs to be voided and a new contract executed (e.g., see FIG. 1). This can result in work delay, and failure of a binding contract if all signatures are not properly executed in the updated contract, especially if the client needs to manage contracts of multiple freelancers.

The client may hire all freelancers directly, which is very time and labor intensive for the client; or s/he can hire a general contractor who subsequently hires at least one subcontractor to actually perform the work. Either method presents considerable time delays, and labor and payment burdens. It is noted that the term “freelancer” is used herein to refer to the general contractor and it also refers to the one or more subcontractors that are hired by the contractor to perform one or more milestones or tasks of the contract. A milestone can be broken into one or more tasks performed by the same or a different subcontractor. A client normally pays when each milestone is completed, or when the entire project is completed.

### Prior Art Exemplification

Prior Art: FIG. 1 illustrates an exemplary prior art problem that requires the contractual process to be repeated whenever new terms (e.g., new milestones or subcontractors) are required. In step 1, the general contractor 106 and the client 108 execute a work contract (i.e., a statement of work—SOW) in an online platform. In step 2, general contractor 106 then hires one or more sub-contractors (i.e., freelancers 102) with specific skills who are able to perform at least one milestone or task required in the job contract. In step 4, the SOW or contract requires updating. For example, a new task is assigned to an existing subcontractor at the client's request. This requires repeating steps 1, 2, 4 by having the client, general contractor, and sub-contractor each execute a new contract, which delays the project and requires further documentation. The project is then completed online in step 6. It is noted that in this prior art scenario, the general contractor is personally liable to the client if any of the sub-contractors fail to perform their work as required in the contract; and the sub-contractor is personally liable to the general contractor and potentially the client. For example, if the client sues the general contractor for breach of contract, then the general contractor must in turn sue the sub-contractor.

Therefore, there is a need within the online work industry for a trusted networked computer system that allows a group of multiple freelancers (i.e., a contractor and at least one subcontractor) to form into a single legal liability entity and thus reduce the number of required contracts for all parties to execute, as well as enabling real-time updates in contracts between contractors and clients, and contractors and their subcontractors.

### SUMMARY OF THE INVENTION

Various embodiments of the present invention comprise a networked computer system, method, and software for an online work platform with a trusted independent payment system that allows a client to hire a general contractor on the platform, who subsequently subdivides a job into multiple milestones that can be performed by different sub-contractors, also hired on the platform by the general contractor. The general contractor and the sub-contractors form a consortium, which is a single legal entity, and the client contracts with the consortium with the general contractor signing as head of the consortium.

In an embodiment, the client receives only a copy of the contractor's contract. The client receives a draft unsigned contract (i.e., a first or a client's contract) between the client and the consortium with the general contractor signing as the representative of the consortium. In an embodiment, the contract's contract outlines the milestones/tasks that the general contractor has assigned to one or more subcontractors (e.g., required work completed, deadlines, fees, etc.)

On the other hand, there is one draft unsigned contract per subcontractor. Each subcontractor's contract is between one subcontractor and the consortium with the general contractor signing as the representative of the consortium (i.e., a subcontractor's contract).

Once the client electronically transmits acceptance of the unsigned contractor's contract between the client and the consortium, the system generates a signed contract by all parties (i.e., an electronically signed contractor's contract and an electronically signed contract for each subcontractor's contract). Thus, all parties only execute one contract with the consortium.

### Contract Amendments

The contract can be easily amended as needed, without requiring all parties to re-sign. When the client requests a new milestone be added or altered to a statement-of-work (SOW), the milestone is broken into at least one task that is assigned to at least one existing or new subcontractor. If a new subcontractor is needed for a new task, the system generates a draft unsigned subcontractor's contract for the new hire and the consortium/general contractor, and electronically transmits a draft unsigned addendum to the client's contract to the client's electronic computing device (i.e., “a client's contract addendum”).

But, if an existing subcontractor is assigned a new task, the system amends the existing subcontractor's contract, e.g., it merely adds a draft unsigned subcontractor addendum to their contract with the consortium/general contractor (i.e., “a subcontractor's contract addendum”).

In either case (a new hire or existing hire), the system electronically transmits to the client electronic computing device a draft unsigned addendum of the client's contract between the client and the consortium/general contractor. When the client transmits approval of their client's contract addendum, then the system automatedly generates signed copies of the client's contract addendum, as well the subcontractor's contract addendum, or the new subcontractor's contract. The electronically signed documents/addendums are stored with the original contracts on the system database as one or more PDFs (e.g., uneditable PDF's).

In an exemplary embodiment, a work contract comprises at least one milestone. Each milestone comprises one or more tasks. One subcontractor is assigned to each task. A subcontractor can be assigned to more than one task. In an embodiment, the client is only billed for each milestone. In another embodiment, the client is billed for each task.

In one or more embodiments, the present invention comprises a Vicoland™ online computer system platform that provides legal functionalities that at each point in the project process ensure the client deals with just one legal entity, i.e., the consortium. The functionalities of the Vicoland™ platform tie together the freelancers, i.e., the contractor and subcontractors participating in a project, into one legal entity. This entity is legally a consortium with freelancers, i.e., the general contractor and subcontractors as consortium members. The consortium is then liable to the client by a single contract.

The single contract is formally made between the Client and the Vico lead (who is the general contractor for the project). This ensures that throughout the whole process—from submitting an offer or job bid, through the actual order, through all changes to an order up to approval, billing and payment—there is always one solid legal structure, the consortium, organized by the online platform, which in turn creates assurance for all sides, clients and freelancers (general contractor and subcontractors). One advantage of the present invention is the formation of a liability proof consortium that is able to change members as needed, e.g., addition of new milestones or tasks requiring new subcontractors with the required skill set.

Another advantage of the present invention is the client having to deal with only a single entity—the general contractor—who is the representative for the entire consortium.

Another advantage of the present invention is the ability to quickly modify or amend the client's contract between the client and the consortium online, and an existing subcontractor assigned a new task, without having to renegotiate the entire terms—e.g., just approve the updates. The platform automatically adds a signed addendum to the existing contract.

Various embodiments of the present disclosure further comprise a networked computer system, method, and computer program product for forming a real-time consortium of freelancers comprising a general contractor and at least one sub-contractor, for an online work platform, comprising:
a) a remote system server connected via a network to a plurality of user electronic computing devices comprising: one or more remote subcontractor electronic computing devices (e.g., personal computers or mobile device); a general contractor electronic computing device (e.g., personal computer or mobile device); and a client electronic computing device (e.g., personal computer or mobile device); and
b) the remote system server comprising: at least one central processing unit; a memory storing a contract generator Vicoland™ application program interface (API) of the present invention; a (e.g. online) network connection; a database of user files, and contracts with updates; and a non-transitory computer-readable storage medium having instructions stored which, when executed by the processor, cause the processor to perform operations disclosed herein, e.g. (a client to hire a consortium comprising a general contractor and at least one subcontractor, to complete a work project broken into at least one multiple milestone, and each milestone is able to be broken into one or more tasks, and the contractor hiring one or more subcontractors to perform the milestones and tasks).

The present invention further comprises utilizing the networked computer system in a computer method and with computer program product for forming a real-time consortium of freelancers for an online work platform, aka a virtual office system, comprising:
a) receiving input from a client electronic computing device over a network, to hire a consortium comprising a general contractor and at least one subcontractor, via an online work platform for a project, and posting a project briefing comprising a plurality of work requirements on a system platform;
b) transmitting from a general contractor electronic computing device, an offer from the general contractor for a project milestone or a task, to one or more sub-contractor electronic computing devices;
c) upon each sub-contractor electronic computing device transmitting acceptance of the general contractor offer, a system processor automatedly generating a consortium draft unsigned contract, wherein all of the one or more freelancers on the project form a consortium; and
d) upon the client computer transmitting acceptance of a consortium offer from the general contractor, the system processor automatedly generating and storing a final signed contract between a client and the consortium comprising the general contractor and the at least one sub-contractor.

The system, method, and computer program product further comprise step (e): updating the contract upon further changes to the original terms, such as scope changes, addition or removal of consortium members etc., wherein the contract is automatically updated from the original contract clauses by adding a signed addendum to the first client's contract between the client and the general contractor/consortium.

In an embodiment, step (d) the computer system, method and computer program product further comprise the system processor converting a signed final contract into a PDF file and storing a copy on a system database.

In an embodiment, the general contractor and the one or more sub-contractors are members of the consortium, and the general contractor is signing the final client's contract as the representative of the consortium.

In an embodiment, the consortium is a single legal entity liable for a work performance delivered by one or more subcontractors and the general contractor.

In an embodiment, the system automatedly generates a draft unsigned contract between the client and the general contractor acting as the head of the consortium; and between the general contractor and each of the one or more subcontractors. The draft is converted into a signed contract by all parties, automated by the system/CPU, when the client computer electronically transmits acceptance of the draft to the system server/CPU.

In an embodiment, the method further comprises transmitting an amendment to the project by the client or general contractor electronic computing device. Upon acceptance of the unsigned draft amended contract by the client, the system processor automatedly generates:
a) signed addendum to the client's contract between the client and the general contractor/consortium; and wherein,
b) the sub-contractor is already in the consortium, generating a signed addendum to the subcontractor's contract between the general contractor/consortium and the sub-contractor who is assigned the new work milestone or task; or
c) the sub-contractor is a new hire, generating a newly signed subcontractor's contract between the sub-contractor and the general contractor/consortium while adding the sub-contractor to the consortium.

Other objectives and advantages of the present invention are disclosed herein.

### BRIEF DESCRIPTION OF THE DRAWINGS

The accompanying figures together with the detailed description below are incorporated in and form part of the specification, serve to further illustrate various embodiments and to explain various principles and advantages all in accordance with the present invention, and should not be construed to limit the invention.

FIG. 1 is a computer flowchart of prior art steps in a client hiring a general contractor on the system, and the general contractor then hiring one or more sub-contractors on the system, and then amending a contract, which requires repeating the contractual process by all parties.

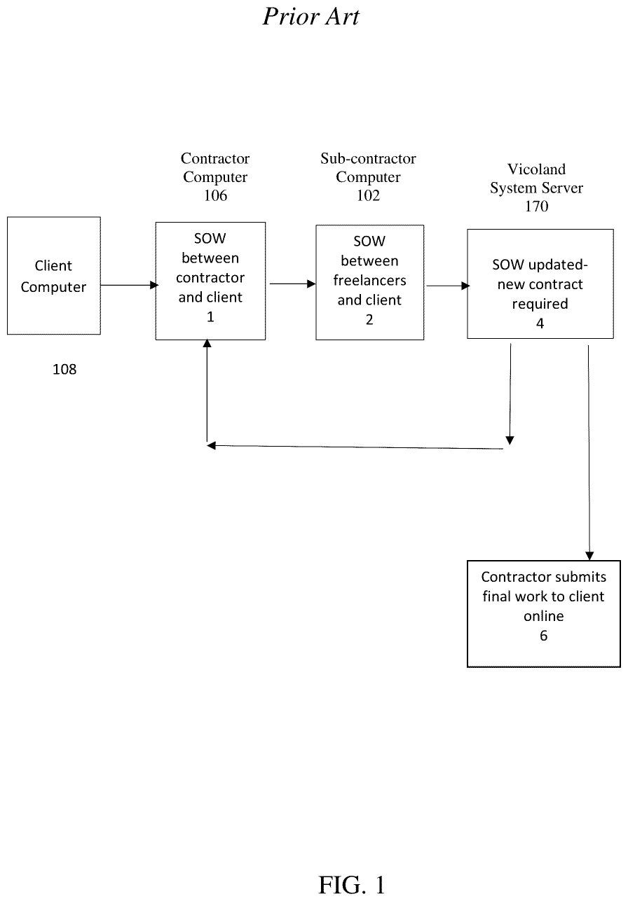

FIG. 2 is a computer flowchart for the primary method steps of real-time consortium building of the present invention, demonstrating that the general contractor and sub-contractor(s) form one consortium, i.e., a contractual body, for the client to contract with.

FIG. 3 is a computer flowchart for the primary method steps of easily amending online a contract between the client and the consortium of the present invention.

FIG. 4 is an exemplary block diagram of the networked computer system of FIGS. 2 and 3 for use in the real-time consortium building methods of the present invention.

FIG. 5 is an exemplary block diagram of the components within the client's, general contractor's, and subcontractors' computers (i.e., users' electronic computing devices).

### DETAILED DESCRIPTION

### Glossary of Terms

Reference will now be made in detail to specific embodiments of the invention. Examples of these embodiments are illustrated in the accompanying drawings. While the invention will be described in conjunction with specific embodiments, it will be understood that it is not intended to limit the invention to these embodiments. On the contrary, the invention is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Unless defined otherwise, all technical and scientific terms used herein have the same meanings as commonly understood by one of ordinary skill in the art to which the invention belongs. Preferred methods, techniques, devices, and materials are described, although any methods, techniques, devices, or materials similar to or equivalent to those described herein may be used in the practice or testing of the present invention. Structures described herein are to be understood also to refer to functional equivalents of such structures.

As used herein, a “computer” refers to one or more apparatuses and/or one or more systems that are capable of accepting a structured input, processing the structured input according to prescribed rules, and producing results of the processing as output. Examples of a computer may include: a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet computer, a personal digital assistant (PDA), a portable or mobile telephone or other mobile computing device; and generally, any apparatus that may accept data, process data according to one or more stored software programs, generate results, and typically include input, output, storage, arithmetic, logic, and control units.

As used herein, a “computer system” may refer to a networked system having one or more computers, where each computer may include computer-readable medium embodying software to operate the computer or one or more of its components. Non-limiting examples of a computer system may include: a distributed computer system for processing information via computer systems linked by a network; and two or more computer systems connected together via a network for transmitting and/or receiving information between the computer systems.

As used herein, the term “processor” and “central processing unit (CPU)” may refer to any device or portion of a device or apparatus that processes electronic data from registers and/or memory to transform that electronic data into other electronic data that may be stored in registers and/or memory. A “computer system” may comprise one or more processors.

As used herein, the term “computer-readable medium” or “computer-readable storage medium or media” refers to any medium (non-transitory) that participates in providing data (for example, instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, memory card, memory stick, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G-5G.

The present invention further comprises software and application program interfaces (APIs) comprising one or more non-transitory computer readable storage media; a processor operatively coupled with the one or more non-transitory computer readable storage media; and program instructions stored on the one or more non-transitory computer readable storage media that, when executed by the processor, interfaces to carry out the methods herein. One or more non-transitory computer-readable storage media storing instructions which, when executed by one or more processors in a computing device associated with a user and having a user interface (UI), implement a method as disclosed herein.

As used herein, the term “Application” and/or “Software” refer to all, or a portion, of a computer program or software code that carries out a specific function and may be used alone or combined with other programs. Examples of software code in applications may include: code segments in one or more computer-readable languages; graphical and or/textual instructions; applets; pre-compiled code; interpreted code; compiled code; and computer programs. Computer program code for carrying out operations for aspects of the various embodiments may be written in any combination of one or more programming languages, such as: an object oriented programming languages and/or conventional procedural programming languages, and/or programming languages such as, for example, Hypertext Markup Language (HTML), Dynamic HTML, HTML5, Extensible Markup Language (XML), Extensible Style sheet Language (XSL), Document Style Semantics and Specification Language (DSSSL), Cascading Style Sheets (CSS), Synchronized Multimedia Integration Language (SMIL), Wireless Markup Language (WML), JAVA; JavaScript, JINI, C, C++, Objective C or any language operable on a wireless platform like iOS, Ruby, Ruby on Rails, Perl, UNIX Shell, Visual Basic or Visual Basic Script, Virtual Reality Markup Language (VRML), ColdFusion™; Adobe Flash & related languages; or other compilers, assemblers, interpreters or other computer languages or platforms.

As used herein, the term “Application Interface” refers to the image displayed on the user's interface of their electronic computing device. For example, the translator may view an application interface on their graphical user interface of their computer that displays unique identifiers in lieu of text.

As used herein, the term “Electronic Computing Device” and “Computer” refers to an end-user's and translator's computer with network connectivity (e.g. Internet) and with a user interface to view and interact with the application interface, such as a laptop, desktop, tablet, etc., as well as any device defined herein as a “computer”.

As used herein, the term “system” and “networked computer system” and “networked system” refer to all of the hardware and software components that are connected via a wired and/or wireless network (e.g., an internet) for carrying out the method steps of the present invention.

As used herein, the term “third-party payment system” refers to an independent platform that is licensed to handle financial payments directly to the financial accounts of the general contractor, sub-contractors, and Vicoland™ platform bank accounts. Non-limiting examples are: Truust™, PayPal™.

As used herein, the term “sub-contractor” and “member” are interchangeable and describe a worker hired by a general contractor to complete a specific task(s) within a milestone of a project, or the entire milestone, or the entire project; while a “freelancer” is a member of the consortium, to include both the general contractor and the one or more sub-contractors.

As used herein, the term “consortium” and “general contractor/consortium” refers to single contractual entity comprising a general contractor and the one or more sub-contractors that are contracted with a general contractor, to complete a specific project for a client. The term “general contractor/consortium” also refers to the general contractor signing a contract for the consortium with the client (i.e., the client's contract). The general contractor and sub-contractors can use different embodiments (such as limited liability company (LLC); S-Corporation (S-Corp); C-Corporation (C-Corp); Inc.; GMBH; etc.) as consortium members. In another embodiment, a consortium is a group of sub-contractors contracted with a general contractor to provide work for a specific project in accordance with contract requirements that are detailed in the contract between the sub-contractors and the general contractor, e.g.: milestones, tasks, timelines, taxes, etc.

As used herein, the term “Legal Consortium” refers to a “legal entity” formed under a specific state or jurisdiction. A legal entity is any company or organization that has legal rights and responsibilities. It is a business that can enter into contracts either as a vendor or a supplier and can sue or be sued in a court of law. It is formed by a general contractor and one or more sub-contractors, together known as the “consortium members”. Exemplary embodiments of a legal consortium members comprise a limited liability company (LLC); S-Corporation (S-Corp); C-Corporation (C-Corp); Inc.; GMBH; etc.

Table 1 lists terms that are used in the exemplary embodiments disclosed herein.

TABLE 1

| TERM | DEFINITION |
|---|---|
| Vico | Virtual company - a consortium of freelancers |
| | with Vico lead as general contractor |
| | performing a project for client(s) |
| Vico lead | Head of a Vico, responsible and general contractor |
| | of a Vico, typically also a freelancer |
| Vico member | A freelancer part of the Vico generally executing tasks |
| | assigned by Vico lead, legally a sub-contractor |
| Client | The main person responsible on the ordering company |
| | side, who can accept offers and deliverables |
| SOW/Contract | Statement of Work - A description of project's |
| | work requirements defining deliverables, timelines |
| | and pricing. Signing SOW executes the contract. |
| Milestone | A deliverable as part of the SOW |
| Task | A task for Vico member, part of Milestone |

### Real-Time Consortium System and Method

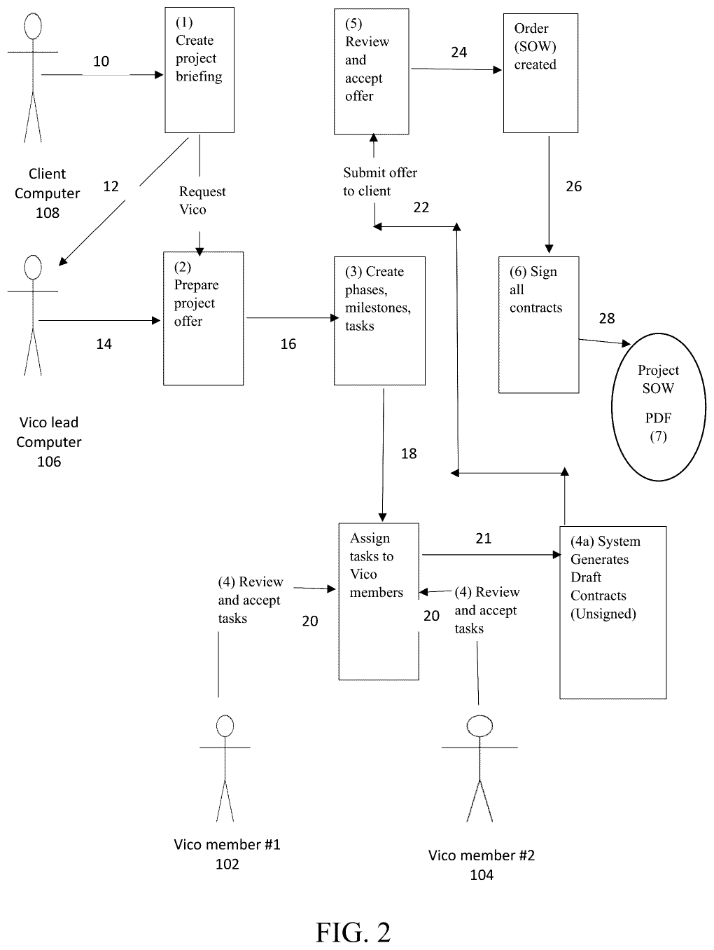

FIGS. 2-5 illustrate exemplary embodiments of the present invention of the networked computer system and method of the present invention that makes all the contractors form into one liability legal entity; and facilitates expeditiously amending the contract online.

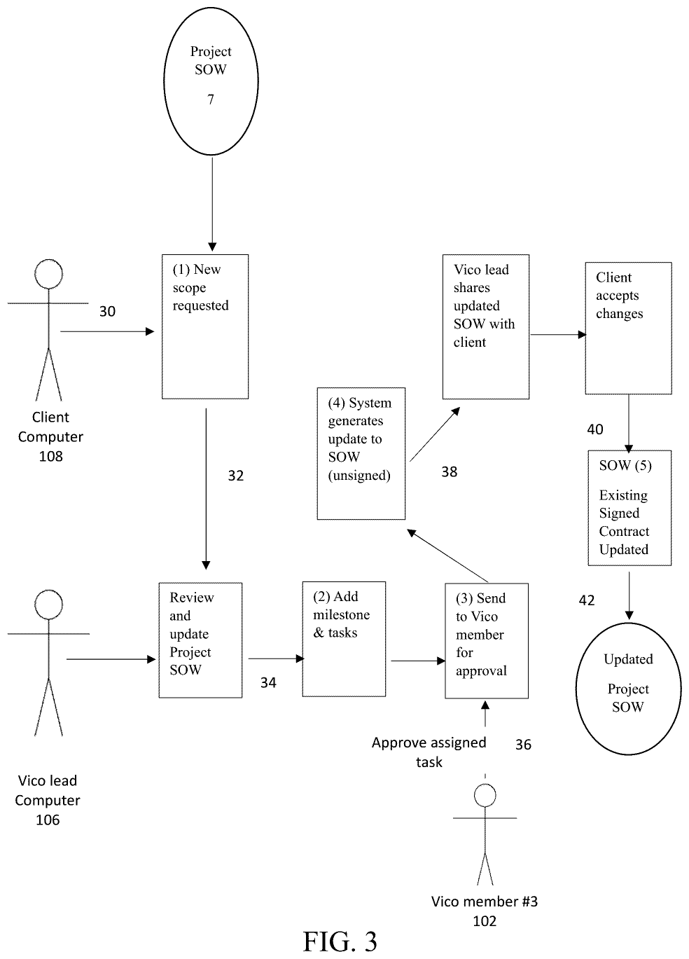

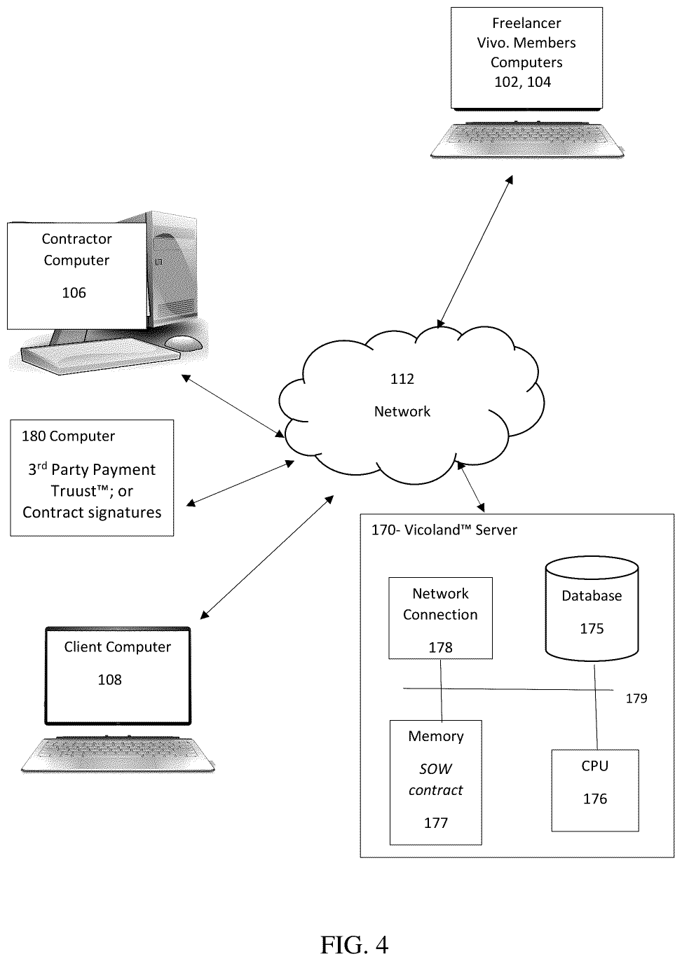

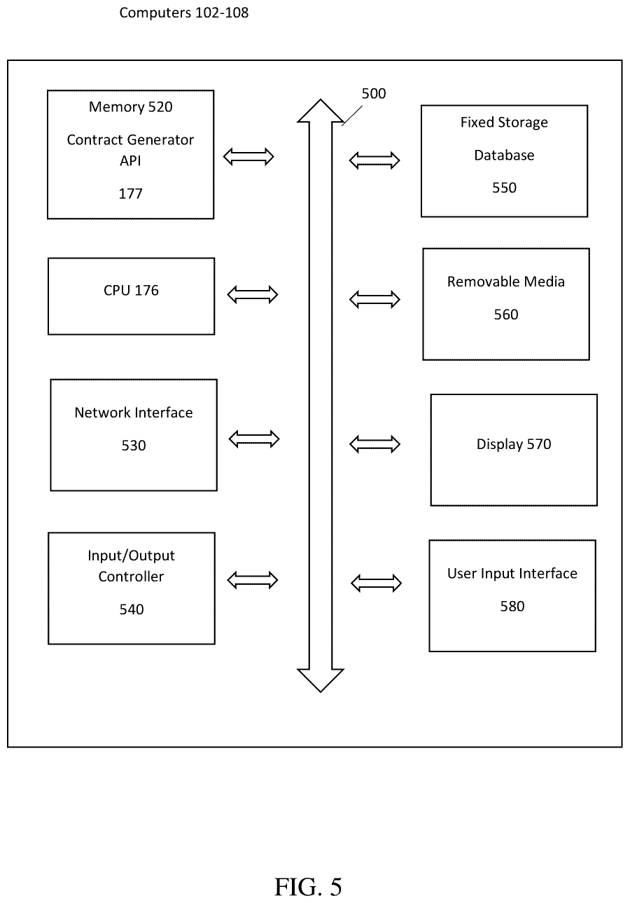

FIG. 2 illustrates a general flowchart for one or more (or a plurality) of subcontractors and a general contractor to form a legal consortium, and then enter into a Statement of Work (e.g., a contract for services) with the client. FIG. 3 illustrates the contract then being amended without having to execute contract amendments between general contractors and sub-contractors. FIG. 4 is a block diagram of the entire computer network system architecture using multiple user computing devices; and FIG. 5 is a block diagram of an exemplary client, general contractor, and/or sub-contractor electronic computing device. Embodiments of the presently disclosed subject matter may be implemented in and used with a variety of components and network architectures. In one or more embodiments, the system may comprise a Software-as-a-Service (SaaS) platform.

As illustrated in FIG. 4, the networked computer system of the various embodiments may comprise, for example: one or more end-user electronic computing devices communicating via a network 112 (e.g., the Internet) with the Vicoland™ online work platform 170. For example, one or more (or a plurality) of user electronic computing devices (e.g., subcontractors 102, 104; general contractor 106; client 108 computers) are in communication with the Vicoland™ server 170 via the network 112.

The user electronic computing devices and Vicoland server 170 and the third-party financial system 180 may also communicate directly via the network 112, and/or with remote servers, databases, cloud computing services and the like. The system may also comprise a separate application server storing the Vicoland application 177 (e.g., SOW contract and amendment), or the application 177 may be stored on the end-user's electronic computing device (102-108).

Network 112 may be a local network, wide-area network, the Internet, or any other suitable communication network or networks, and may be implemented on any suitable platform including wired and/or wireless networks. The electronic computing devices 102-108 may connect to the network 112 via a variety of methods, such as a phone modem, wireless (cellular, satellite, microwave, infrared, radio, etc.) network, Local Area Network (LAN), Wide Area Network (WAN), or any such means as necessary to communicate with the Vicoland platform server 170, and other end user devices.

The network may also comprise several types of computer system configurations, including personal computers, hand-held devices, multi-processor systems, microprocessor-based or programmable consumer electronics, network PCs, minicomputers, mainframe computers, and the like. Where appropriate, embodiments may also be practiced in data centers, cloud computing environments, Software as a Service (SaaS) environments, or other distributed computing environments where tasks are performed by local and remote processing devices that are linked (either by hardwired links, wireless links, or by a combination thereof) through a communications network. In a distributed computing environment, program modules may be located in both local and remote memory storage devices.

Various embodiments of the presently disclosed subject matter may include or be embodied in the form of computer-implemented methods or processes and apparatuses for practicing those methods or processes; and/or, in the form of a computer program product having computer program code containing instructions embodied in non-transitory and/or tangible media, e.g., CD-ROMs, hard drives, USB (universal serial bus) drives, or any other machine readable storage medium, wherein, when the computer program code is loaded into and executed by a computer (e.g. device 102-108), the computer becomes an apparatus for practicing embodiments of the disclosed subject matter.

The various embodiments also may be embodied in the form of computer program code (e.g., Vicoland™ SOW Contract API 177) or a mobile app associated with Vicoland server 170 or the third-party server 180. For example, whether stored in a storage medium or media, loaded into and/or executed by a computer, or transmitted over some transmission medium, such as over electrical wiring or cabling, through fiber optics, or via electromagnetic radiation, wherein when the computer program code is loaded into and executed by a computer (e.g. devices 102-108), the computer becomes an apparatus or electronic computing device for practicing embodiments of the disclosed subject matter. When implemented on a general-purpose microprocessor, the computer program code segments configure the microprocessor to create specific logic circuits. In some configurations, a set of computer-readable instructions stored on a non-transitory computer-readable storage medium may be implemented by a general-purpose processor, which may transform the general-purpose processor or a device containing the general-purpose processor into a special-purpose device configured to implement or carry out the instructions.

Lastly, the various embodiments may be implemented using hardware that may include a processor, such as a general-purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

### Real-Time Consortium Method

Now referring to FIGS. 2-5: in FIG. 2, step 10, the client electronic computing device 108 electronically transmits a “Project Briefing 1” via the internet 112 to the Vicoland™ Server 170 (e.g., see FIG. 4). Project Briefing 1 contains all the information that a general contractor (Vico) needs to create a detailed offer for the service requested by the client. The Project Briefing 1 is posted online for public viewing in step 12 by all the general contractors on a Vicoland™ website/platform, where a plurality of general contractors can submit an offer or bid for the client's posted job.

In step 14, at least one general contractor electronic computing device (e.g., computer) 106 electronically receives Project Briefing 1 (e.g., via the internet 112); and the general contractor begins to prepare a bid or offer 2 for the client. The offer or bid 2 summarizes all work that is expected to be delivered to the client with due dates, prices and a detailed description of the scope of work.

In step 16, general contractor computer 106 receives general contractor input for subdividing the Project Briefing 1 into three levels comprising: phases, milestones, and/or tasks that are each to be completed by one or more subcontractors hired via the general contractor on the Vicoland™ platform 170. A phase is a higher-level division of the project into logical parts. A milestone is a main deliverable, with a payment and due dates assigned to it; and a task is the smallest of the offer. A milestone may have one or more tasks assigned to one or more subcontractors with a skill set specific to the task requirements. (See Table 2 for exemplary computer code for general contractor building an offer for a client's wishes to subdivide the job).

TABLE 2

```
// Vico Lead building the offer for specific needs of project
function prepareOfferDraft(project)
offer = createOffer(project)
  phase = createNewPhase(offer)
  milestones = createMilestones(phase)
  tasks = createTasks(milestones)
  return offer
end
```

In step 18, general contractor computer 106 electronically transmits the offer details to the subcontractor computers (102, 104, etc.), and receives each subcontractor's approval 4 in return (step 20). For example, the subcontractor transmits approval to perform a specific task.

In step 21, the Vicoland server (CPU 176) generates an unsigned draft subcontractor's contract 4a between each subcontractor and the general contractor/consortium, which lists all the job details that the subcontractor must perform, e.g., milestones, tasks, timelines or deadlines, amount earned, and taxes deducted. (See exemplary computer code in Table 3). And the system automatedly generates an unsigned client's contract between the client and the consortium.

```
TABLE 3
// generate contracts with signatures for all parties
function generateContracts(order)
  clientVicoLeadPdfContract = generateContract(CLIENT_WITH_VICOLEAD, order)
  foreach vicoMember in order.vico:
    vicoLeadVicoMemberContract =
generateContract(VICO_LEAD_VICO_MEMBER, order)
end
```

In step 22, general contractor computer 106 acting as the head of the consortium, then electronically transmits the draft unsigned client's contract 5 to the client computer 108, which includes the contract terms between the consortium and client, and the milestones/tasks between the general contractor and the subcontractors(s).

And in step 24, client computer 108 receives client input for accepting or declining the offer, which is electronically transmitted to the Vicoland™ server 170. (See exemplary computer code for step 22 in Table 4). The client reviews the offer details (e.g., the unsigned draft contract).

TABLE 4

```
// high level process of building the consortium for a project
function buildRealtimeConsortium(project)
  offer = prepareOfferDraft(project)
  result = submitOfferToClient(offer)
  if result.declined?
    updateOffer(offer)
    result = submitOfferToClient(offer)
  if result.approved?
    order = createOrderFromOffer(order)
    contracts = generateContracts(order)
end
```

In step 26, Vicoland CPU 176 generates a plurality of final signed contracts (SOW's 6) upon receiving the client electronically transmitted acceptance of the general contractor's/consortium's offer. The signed contracts 6 comprise: a signed client's contract between the client and the general contractor, e.g., acting as the head of the consortium; and a plurality of signed subcontractor's contracts between the general contractor and each subcontractor (e.g., one contract per each subcontractor).

In step 28, Vicoland CPU 176 converts the signed contract(s) into a PDF format (e.g., uneditable PDF) and securely stores the PDF(s) on the system database 175, as one or more PDF's (i.e., Project SOW 7). The system transmits a copy of the final PDF client's contract to the client computer 108 (See exemplary computer code for step 26 in Table 5). Additionally in an embodiment, the system may also transmit to the general contractor's computer 106 a copy of the client's contract and/or the subcontractor's contract. Additionally in an embodiment, the system may also transmit a final PDF of the subcontractor's contract to each subcontractor computer 102, 104. In an additional, or alternative embodiment, copies of the PDF's are available online for user viewing and downloading by the signatory parties. At this point, the work beings.

TABLE 5

```
// generate the PDF file and securely store it
function generateContract(contractType, order)
  contractData = extractContractData(order)
  pdfTemplate = loadPdfTemplate(contractType)
  contract = populateDataInTemplate(pdfTemplate, contractData)
  storeContract(contract)
  return contract
end
```

In an embodiment, the PDFs are non-editable, read only.

In one embodiment, a legal consortium is formed by the subcontractors and the general contractor. In an additional embodiment, the Vicoland system 170 (i.e., FIG. 4; CPU 176, network 178, etc.) is able to automatedly generate, pay, and electronically transmit an online application to the appropriate government entity (e.g. a Secretary of State Office) to form the legal consortium if the general contractor feels that this is necessary.

In an additional embodiment, as the milestones are met, an electronic message is sent to the client computer comprising a well-defined set of instructions and the monetary value that the client is billed upon successfully completion of the work milestone. Only one invoice is transmitted to client computer 108 for a completed work task (e.g., milestone) no matter how many subcontractors were required to be hired for that work task.

### Amending SOW

When the client requests additional scope to be added to the project, a new subcontractor may need to be hired who has a special skill set needed to complete a newly assigned task or milestone. This requires amending the final signed, stored SOW's 7 and/or the final signed contract 6.

Referring to FIG. 3: in step 30, the client computer 108 receives client input to amend the SOW 6 or 7 with a new milestone, and in step 32 an electronic message is transmitted to the Vicoland server 170 (and/or directly to computer 106) for viewing on the general contractor computer 106. In an alternative embodiment, general contractor computer 106 initiates the amended contract.

In step 34, the general contractor computer 106 receives input from the general contractor for assigning a subcontractor to a new milestone/task 2, which may require hiring one or more new subcontractors or assigning one or more current subcontractors with the new task(s). The electronic message is sent to the subcontractor computer 102 and receives back approval by the subcontractor (step 36). Note, the existing subcontractor and general contractor do not have to execute a new draft unsigned subcontractor's contract, as in the prior art. Instead, once the existing subcontractor inputs acceptance, the Vicoland CPU 176 automatedly generates an updated unsigned draft SOW 4, comprising an addendum to contractor's contract, and an addendum to the subcontractor's contract (step 38). The draft unsigned client's contract addendum is electronically transmitted to client computer 108.

Alternatively in step 34, if a new subcontractor is required for the new milestone/task, a draft unsigned subcontractor contract is generated between the new subcontractor and the consortium/contractor, while only an addendum is added contractor's contract. Both are added to SOW 4, unsigned. And a draft unsigned client's contract addendum is electronically transmitted to client computer 108.

In step 40, upon client computer 108 transmitting acceptance of the draft unsigned amended SOW 4, (i.e., the client's contract addendum) then the Vicoland CPU 176 generates a final signed amended SOW 5, comprising: a signed client's contract addendum; and, 1) one or more signed existing subcontractor's contract addendums, or 2) one or more signed new subcontractor's contracts.

In step 42, CPU 176 then automatedly generates and stores remotely and/or on the system database 175 one or more PDF(s) (e.g., uneditable PDFs) of the original signed client's contract with an addendum(s) (or new subcontractor contract) (step 42). Thus, the updated SOW 7 comprises: the signed client's contract and signed client's addendum with the consortium; and the signed contracts per each existing and new subcontractor with the consortium, and signed subcontractors' contract addendum(s).

In an embodiment, the general contractor is signing as the director of the consortium, which is analogous to a CEO of a company signing a contract with an employee or subcontractor, and wherein the consortium is the company.

### Computer Program Product

The present invention further comprises a computer program product comprising a non-transitory computer readable storage medium having instructions stored which, when executed by a computing device, cause the computing device to perform operations comprising the methods disclosed herein.

For example, the present invention further comprises computer code for executing one or more of the methods disclosed herein, such as a contract generating code stored on the system server (FIG. 4, 170) accessible via the internet or code stored on a user's mobile device using a mobile app. The contract generating code may further comprise computer code for additional features of the present invention: hiring one or more subcontractors; contracting between client and general contractor, which may be a consortium; forming a consortium, which may include filing with government entity; generating one invoice and receiving payment between client and general contractor/consortium, which subsequently automatedly pays subcontractors. It is noted that the entire contents of U.S. patent application Ser. No. 18/336,988 filed Jun. 17, 2023, and entitled “Smart Payroll System, Method and Computer Program Product”, which is by the same inventive entity, is hereby incorporated herein in its entirety, especially pertaining to methods of automated payment to all parties.

### Client, General Contractor, Subcontractor(s) Computer

As illustrated in FIG. 5, the end-users' electronic computing device (FIG. 4, computers 102-108) comprises, e.g.: an internal bus 500 connecting the major components of each device to its central processing unit (i.e., processor or microprocessor) 176 and memory 520. Devices 102-108 have the ability to transmit and receive electronic communications via a network interface 530 which allows the devices and servers to communicate with each other via one or more local, wide-area, or other networks. Furthermore, devices 102-108 may comprise any one of the following operating systems (OS), for example: Android or Windows or Apple, such as smartphones, tablets, laptops, desktops, etc.

The network interface 530 may provide a direct connection to a remote server (e.g. Application Server 177 and/or Third-party server 180 of FIG. 4) via an internet service provider (ISP), or a direct connection to a remote server via a direct network link to the Internet via a POP (point of presence) or other technique. The network interface 530 may connect the computers using wireless techniques, including digital cellular telephone connection, Cellular Digital Packet Data (CDPD) connection, digital satellite data connection or the like.

Memory 520 comprises read-only memory (ROM) or flash memory containing Basic Input-Output system (BIOS) controlling basic hardware operation including interaction with peripheral components. Memory 520 further comprises random access memory (RAM) comprising the main memory into which the device's operating system (e.g., Android or Windows or Apple), and application programs (e.g., Contract Generator Mobile apps for 177, 180) are loaded. The application programs can be stored on and accessed via a non-transitory computer readable storage media, such as a hard disk drive (e.g., fixed storage 550), an optical drive, floppy disk, or other storage medium.

Bus 500 further connects an input/output controller 540, a user display 570, such as a display screen via a display adapter, a user input interface 580, which may include one or more controllers and associated user input devices such as a keyboard, mouse, touchscreen and the like, a fixed storage 550 (such as a hard drive, flash storage, Fiber Channel network, SAN device, SCSI device, and the like), and a removable media component 560 operative to control and receive an optical disk, flash drive, and the like. The fixed storage 550 may be integrated with the device 102-108 or it may be separated and accessed through other interfaces. Computer program code to implement the various embodiments can be stored in non-transitory computer-readable storage media, such as one or more of the memory 520, fixed storage 550, removable media 560, or on a remote storage location (e.g., cloud database/server).

The user input interface 580 enables a user to enter data and/or instructions to the device 102-108 through one or more corresponding input devices, such as an image scanner w/camera, a touch screen, a keyboard, a mouse, a trackball, a light pen, stylus, or other pointing device, a microphone, and the like. Similarly, examples of input interfaces 580 that may be used to connect the input devices to the bus 500 include a serial port, a parallel port, a game port, a universal serial bus (“USB”), a firewire (IEEE 1394), or another interface. Lastly, output interfaces connect one or more corresponding output devices to the bus 500, such as a monitor or display screen 570, a speaker, a printer, and the like. An output device can be integrated with or peripheral to device, such as a video adapter, an audio adapter, a parallel port, and the like.

### CONCLUSION

The aforementioned computer flowcharts or block diagrams illustrate the architecture, functionality, and operation of possible implementations of systems, methods, and apparatuses comprising computer program products (aka computer code) and/or computer-usable medium having computer-readable program code stored thereon according to various embodiments of the present invention. In this regard, a step(s) in the computer flowcharts or block diagrams may represent a module, segment, or portion of code, which comprises one or more executable instructions for implementing the specified logical function(s).

It should also be noted that, in some alternative implementations, the functions noted in the diagrams may occur out of the order noted in the figures. For example, steps shown in succession may, in fact, be executed substantially concurrently, or the steps may sometimes be executed in the reverse order, depending upon the functionality involved. It will also be noted that each step of the computer flowcharts or block diagrams, and combinations of steps, can be implemented by special purpose hardware-based systems that perform the specified functions or acts, or combinations of special purpose hardware and computer instructions.

And, in the above description, an embodiment is an example or implementation of the inventions. The various appearances of “one embodiment,” “an embodiment” or “some embodiments” do not necessarily all refer to the same embodiments.

The transitional term “comprising”, which is synonymous with “including,” “containing,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention.

Unless specifically stated otherwise, and as may be apparent from the description and claims herein, terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

As used herein, the term “substantially” refers to about or at 100%; and the term “about” refers to 5-10%, or 0-5% the stated amount.

As used herein, the terms “at least one”, “one or more”, and “a plurality” can be used interchangeably.

The various embodiments may also be implemented in an operating environment comprising computer-executable instructions (for example, software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages.

Trademarks: The product names used in this document are for identification purposes only. All trademarks and registered trademarks are the property of their respective owners.

What is claimed is:

1. A networked computer method for forming a real-time consortium comprising a general contractor and one or more subcontractors for an online work platform, comprising:
a) receiving input from a client electronic computing device over a network, to hire a general contractor via an online system work platform for a project, and posting a project briefing comprising a plurality of work requirements for the project on the system work platform;
b) dividing the project into one or more milestones, and transmitting from a general contractor electronic computing device to one or more subcontractor electronic computing devices, an offer from the general contractor for a project task, wherein the one or more milestones comprises at least one task per milestone assigned to a subcontractor;
c) upon each subcontractor electronic computing device transmitting acceptance of the general contractor offer, a system processor automatedly generating and transmitting to the client electronic computing device, a draft unsigned client contract with a consortium, wherein all of the general contractor and the one or more subcontractors on the project form the consortium; and
d) upon the client computer transmitting acceptance of the consortium offer, the system processor automatedly generating a signed client's contract between a client and the consortium, and a signed subcontractor's contract between the general contractor and each of the one or more subcontractors.

2. The networked computer method of claim 1, further comprising in step (d) the system processor converting the client's and each of the subcontractor's signed final contracts into a PDF file and storing on a system database, or on a remote or cloud-based storage device.

3. The networked computer method of claim 1, wherein the general contractor and the one or more subcontractors are members of the consortium, and the general contractor is signing the client's contract and the subcontractors' contracts as the representative for the consortium.

4. The networked computer method of claim 3, wherein the consortium is a single legal entity with liability protection for a work performance for the one or more subcontractors and the general contractor.

5. The networked computer method of claim 1, further comprising transmitting an amendment to the project by the client or general contractor electronic computing device, wherein the amendment comprises altering an existing milestone or task, or adding a new milestone or task.

6. The networked computer method of claim 5, further comprising upon acceptance of the amendment by the one or more subcontractors and/or the general contractor, the system processor automatedly generating and transmitting to the client electronic computing device an unsigned addendum to the client's contract.

7. The networked computer method of claim 6, further comprising upon the client electronic computing device transmitting acceptance of the unsigned addendum to the client's contract, the system processor automatedly generating:
a) a signed addendum to the client's contract between the client and the consortium; and wherein,
b) the subcontractor is already in the consortium, generating an addendum to the signed subcontractor's contract between the general contractor and the subcontractor assigned to the new task; or
c) the subcontractor is a new hire, generating a new signed subcontractor's contract between the subcontractor and the general contractor while adding the subcontractor to the consortium.

8. A networked computer system for forming a real-time consortium of freelancers for an online work platform, comprising:
a remote system server (170) connected via a network (112) to a plurality of user computers, comprising: one or more remote subcontractor computers (102, 104); a general contractor computer (106); and a client computer (108);
the remote system server (170) comprising: at least one central processing unit; a memory storing a contract generator application program interface (API); a network connection; a database of user files; and a non-transitory computer-readable storage medium having instructions stored which, when executed by the processor, cause the processor to perform operations comprising:
a) receiving input from a client electronic computing device over a network, to hire a general contractor via an online system work platform for a project, and posting a project briefing comprising a plurality of work requirements for the project on the system work platform;
b) dividing the project into one or more milestones, and transmitting from a general contractor electronic computing device to one or more subcontractor electronic computing devices, an offer from the general contractor for a project task, wherein the one or more milestones comprises at least one task per milestone assigned to a subcontractor;
c) upon each subcontractor electronic computing device transmitting acceptance of the general contractor offer, a system processor automatedly generating and transmitting to the client electronic computing device, a draft unsigned client contract with a consortium, wherein all of the general contractor and the one or more subcontractors on the project form the consortium; and
d) upon the client computer transmitting acceptance of the consortium offer, the system processor automatedly generating a signed client's contract between a client and the consortium, and a signed subcontractor's contract between the general contractor and each of the one or more subcontractors.

9. The networked computer system of claim 8, further comprising in step (d) the system processor converting one or more final signed contracts into a PDF file and storing on a system database, or on a remote or cloud-based storage device.

10. The networked computer system of claim 8, wherein the general contractor and the one or more subcontractors are members of the consortium, and the general contractor is signing the client's contract and the subcontractors' contracts as the representative for the consortium.

11. The networked computer system of claim 10, wherein the consortium is a single legal entity with liability protection for a work performance for one or more subcontractors and the general contractor.

12. The networked computer system of claim 8, further comprising transmitting an amendment to the project by the client or general contractor electronic computing device, wherein the amendment comprises altering an existing milestone or task, or adding a new milestone or task.

13. The networked computer system of claim 12, further comprising upon acceptance of the amendment by the one or more subcontractors and/or the general contractor, the system processor automatedly generating and transmitting to the client electronic computing device, an unsigned addendum to the client's contract.

14. The networked computer system of claim 13, further comprising upon the client electronic computing device transmitting acceptance of the unsigned addendum to the client's contract, the system processor automatedly generating:
a) a signed addendum to the client's contract between the client and the consortium; and wherein,
b) the subcontractor is already in the consortium, generating an addendum to the signed subcontractor's contract between the general contractor and the subcontractor assigned to the new task; or
c) the subcontractor is a new hire, generating a new signed subcontractor's contract between the subcontractor and the general contractor while adding the subcontractor to the consortium.

15. A computer program product comprising a non-transitory computer readable storage medium having instructions stored which, when executed by a computing device, cause the computing device to perform operations comprising:
a) receiving input from a client electronic computing device over a network, to hire a general contractor via an online system work platform for a project, and posting a project briefing comprising a plurality of work requirements for the project on the system work platform;
b) dividing the project into one or more milestones, and transmitting from a general contractor electronic computing device to one or more subcontractor electronic computing devices, an offer from the general contractor for a project task, wherein the one or more milestones comprises at least one task per milestone assigned to a subcontractor;
c) upon each subcontractor electronic computing device transmitting acceptance of the general contractor offer, a system processor automatedly generating and transmitting to the client electronic computing device, a draft unsigned client contract with a consortium, wherein all of the general contractor and the one or more subcontractors on the project form the consortium; and
d) upon the client computer transmitting acceptance of the consortium offer, the system processor automatedly generating a signed client's contract between a client and the consortium, and a signed subcontractor's contract between the general contractor and each of the one or more subcontractors.

16. The computer program product of claim 15, further comprising in step (d) the system processor converting one or more signed final contracts into a PDF file and storing on a system database, or on a remote or cloud-based storage device.

17. The computer program product of claim 15, wherein the general contractor and the one or more subcontractors are members of the consortium, and the general contractor is signing the client's contract and the subcontractors' contracts as the representative for the consortium.

18. The computer program product of claim 15, wherein the consortium is a single legal entity with liability protection for a work performance for one or more subcontractors and the general contractor.

19. The computer program product of claim 15, further comprising transmitting an amendment to the project by the client or general contractor electronic computing device, wherein the amendment comprises altering an existing milestone or task, or adding a new milestone or task.

20. The computer program product of claim 19, further comprising upon acceptance of the amendment by the one or more subcontractors, the system processor automatedly generating and electronically transmitting to a client electronic computing device, an unsigned addendum to the client's contract.

21. The computer program product of claim 20, further comprising upon the client electronic computing device transmitting acceptance of the unsigned addendum to the client's contract, the system processor automatedly generating:
a) a signed addendum to the client's contract between the client and the consortium; and wherein,
b) the subcontractor is already in the consortium, generating an addendum to the signed subcontractor's contract between the general contractor and the subcontractor assigned to the new task; or
c) the subcontractor is a new hire, generating a new signed subcontractor's contract between the subcontractor and the general contractor while adding the subcontractor to the consortium.
